(19) United States
(12) Patent Application Publication
(10) Pub. No.: US 2014/0151161 A1
(43) Pub. Date: Jun. 5, 2014

(54) CAR STOP PLATE

(71) Applicant: PO I. CHENG, Taipei City (TW)

(72) Inventor: PO I. CHENG, Taipei City (TW)

(21) Appl. No.: 13/706,337

(22) Filed: Dec. 5, 2012

(51) Int. Cl. B60T 3/00

(52) U.S. Cl. CPC B60T 3/00
USPC 188/32

(57) ABSTRACT

A car stop plate includes a stop having a penetrating hole for locking or being penetrated by other tool for retaining; a supporting sheet extending from a lower side to a predetermined distance; widths of the supporting sheet being reduced from an end near the stop to a front end; a length of the supporting sheet being based on a distance from lowest point of a wheel of a car to a foremost or rearmost of the car. In use, the stop resists against a front wheel of a car; the wheel of the car will press the supporting sheet so as to retain the supporting sheet motionlessly. When a driver desires to park a car, the car can be stopped quickly by resisting against the car stop plate in a specific position.

### FIELD OF THE INVENTION

The present invention relates to cars, and in particular to a car stop plate which provides a convenient way for parking a car.

### BACKGROUND OF THE INVENTION

In parking a car to a parking space, generally, the care cannot be exactly positioned with the lattice of the parking space so that it is possible that the car collides a wall around the lattice or another car aside the lattice. Therefore, car stop plates are designed for stopping a car in a parking lattice.

In use of car stop plates, it needs to measure a distance between the car and an obstacle so as to locate the car stop plate to a suitable position. However, this is inconvenient to uses.

However, the prior art car stop plate has the defect that: installation and detachment of the car stop plate need uses other tools. Furthermore, the ground must be destroyed for installing the car stop plate. After installation, the car stop plate is fixed and thus motionless, but this is inconvenient to suit for many different states concurrent in a parking lot.

Therefore, there is an eager demand for a novel design which can improve above mentioned defects in the prior art.

### SUMMARY OF THE INVENTION

Accordingly, the object of the present invention is to provide a car stop plate, in that when a driver desires to park a car, the car can be stopped quickly by resisting against the car stop plate of the present invention in a specific position. Furthermore, the present invention includes many different modules which can be assembled by matching one element to another one.

To achieve above object, the present invention provides a car stop plate, comprising: a stop having a penetrating hole for locking or being penetrated by other tool for retaining the stop; a supporting sheet extending from a lower side to a predetermined distance; widths of the supporting sheet being reduced from an end near the stop to a front end; wherein in use, the stop resists against a front wheel of a car; the wheel of the car will press the supporting sheet so as to retain the supporting sheet motionlessly.

The present invention further provides a car stop plate comprising: a stop having a penetrating hole for locking or being penetrated by other tool for retaining the stop; and a supporting sheet extending from a lower side to a predetermined distance and being formed with a front end; thicknesses of the supporting sheet are reduced from a end near the stop to the front edge; and an engaging sheet having a rear edge for engaging to the front edge of the supporting sheet;

### BRIEF DESCRIPTION OF THE DRAWINGS:

FIG. 1 is a perspective view of the car stop plate of the present invention.

FIG. 2 is another perspective view of the car stop plate of the present invention.

FIG. 3 shows a first schematic view about the operation of the present invention.

FIG. 4 shows a second schematic view about the operation of the present invention.

FIG. 5 shows a third schematic view about the operation of the present invention.

FIG. 6 shows a fourth schematic view about the operation of the present invention.

FIG. 7 is a schematic view showing another embodiment of the present invention.

FIG. 8 is a perspective view showing a further embodiment of the present invention.

FIG. 9 shows the backside of the further embodiment of the present invention.

FIG. 10 is a perspective view showing another design of the engaging sheet in the further embodiment of the present invention.

FIG. 11 shows the application in FIG. 10 of the present invention.

FIG. 12 shows another structure about the stop of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

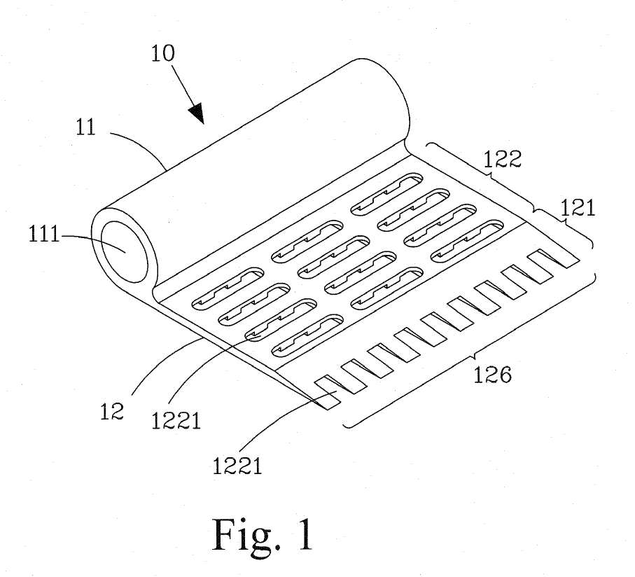

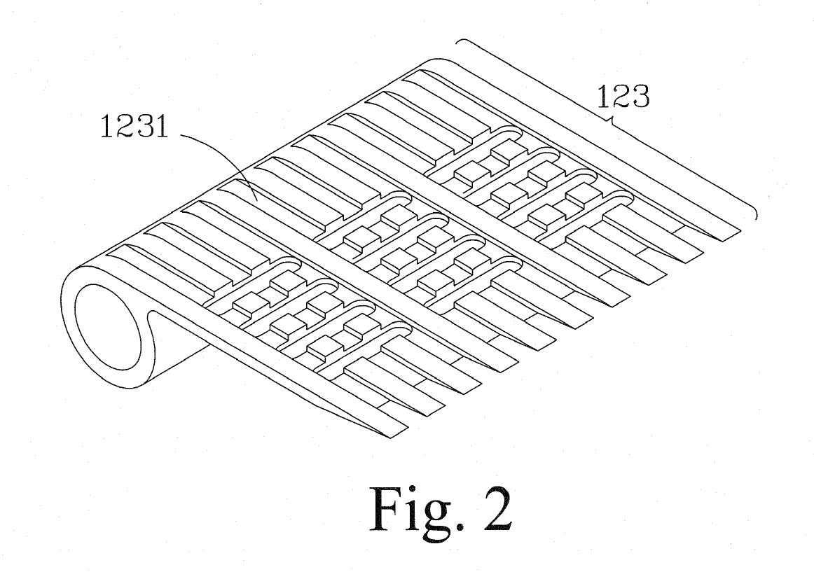

With reference to FIGS. 1 and 2, the structure of the car stop plate of the present invention is illustrated.

The present invention includes a stop 11 having a penetrating hole 111 for locking or being penetrated by other tool for retaining it.

A supporting sheet 12 extends from a lower side to a predetermined distance. Widths of the supporting sheet 12 are reduced from an end near the stop 11 to a front end 126. A length of the supporting sheet 12 is based on a distance from lowest point of a wheel of a car to a foremost or rearmost of the car.

An upper side of the supporting sheet 12 is formed as a first action area 121, and a second action area 122. A lower side opposite to the upper side of the supporting sheet 12 is formed as a third action area 123. The first action area 121 is near the stop 11 and the second action area 122 is extended from a front end of the first action area 121.

The first action area 121 is formed with a plurality of holes 1211. The second action area 122 is formed with a plurality of notches 1221. The third action area 123 is formed with a plurality of recesses 1231.

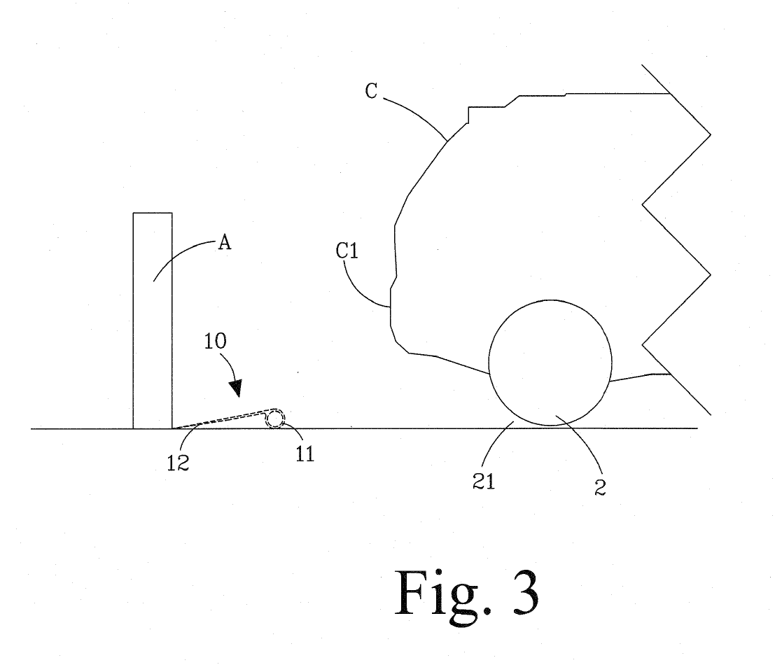

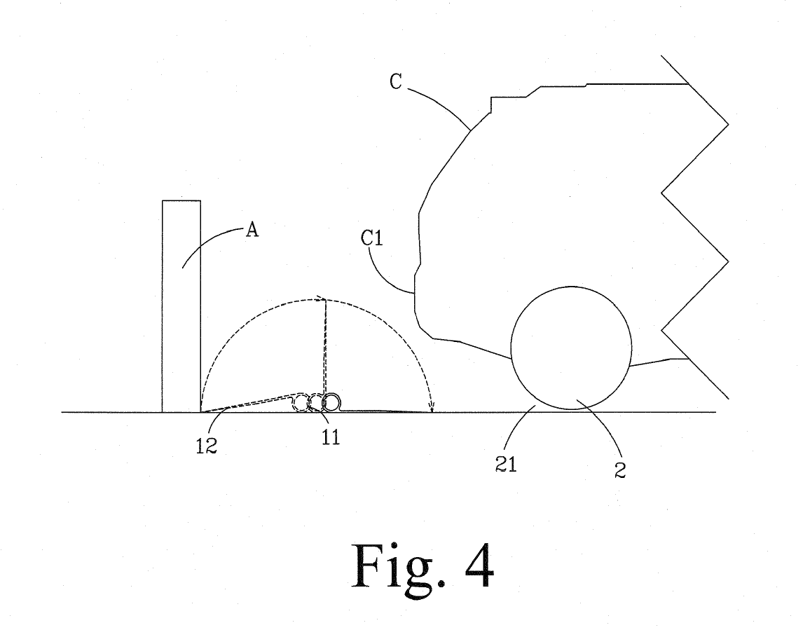

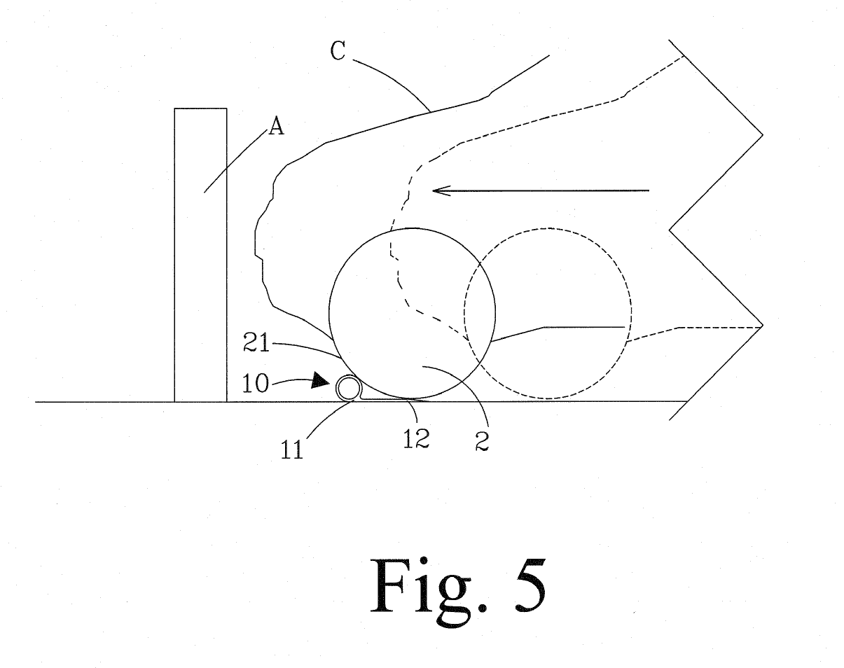

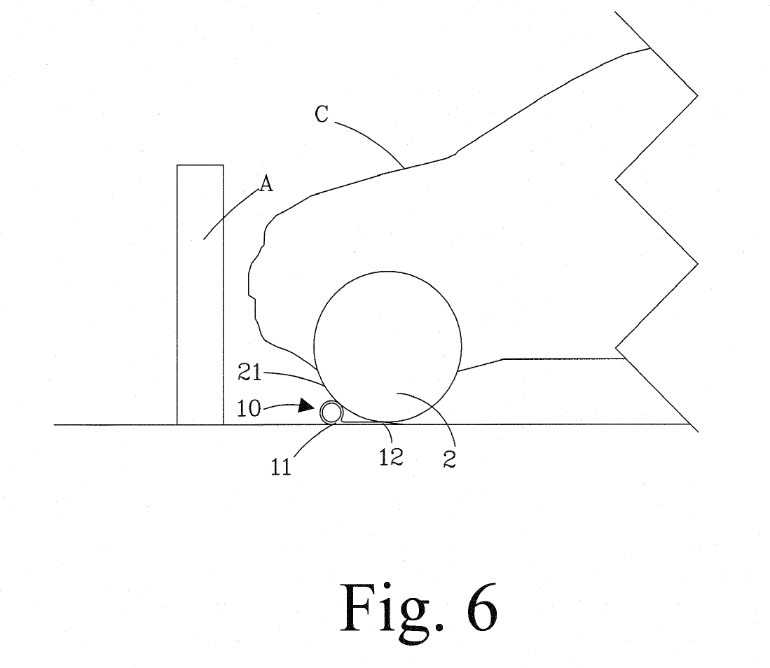

In use, the stop 11 resists against a front wheel 2 of a car C. The wheel 2 of the car will press the supporting sheet 12 so as to retain the supporting sheet 12 motionlessly. Referring to FIGS. 3, 4, 5 and 6, the usage of the car stop plate of the present invention is illustrated. See FIG. 3, initially, the car stop plate of the present invention is located near a wall A. Then referring to FIG. 4, the car stop of the present invention is turned repeatedly so to a position near the wheel 2 of car C, as illustrated in FIG. 5. Then as shown in FIG. 6, the car C then moves to cause an edge 21 of the wheel 2 resists against the stop 11 of the car stop plate of the present invention. Thus, the car C will not collide with the wall A. The first action area 121 and second action area 122 of the supporting sheet 12 will increase the friction force between the wheel 2 and the car stop plate. The holes 1121 and the notches 1221 will drain water from the first action area 121 and the second action area 122. The third action area 123 provides friction force between the car stop plate and ground.

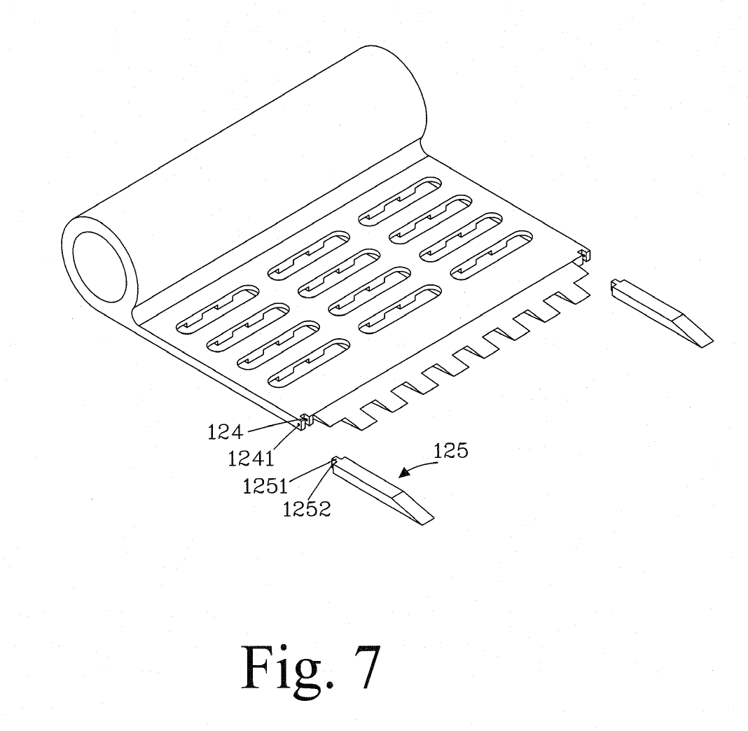

With reference to FIG. 7, another embodiment of the car stop plate of the present invention is illustrated. It is illustrated that two sides of the front edge of the first action area 121 exposes out and each expose front side is formed with a groove 124 for receiving a respective engaging rod 125.

In detail, each lateral side of each groove 124 is formed with a penetrating hole 1241. Each engaging rod 125 has a protruded stem 1251 which is formed with an engaging hole 1252. In assembly, a stud passes through the penetrating holes 1241 of the groove 124 and the engaging hole 1252 of the engaging rod 125 so as to retain the engaging rod 125 to the first action area 121 so that the length of the whole supporting sheet 12 is prolonged.

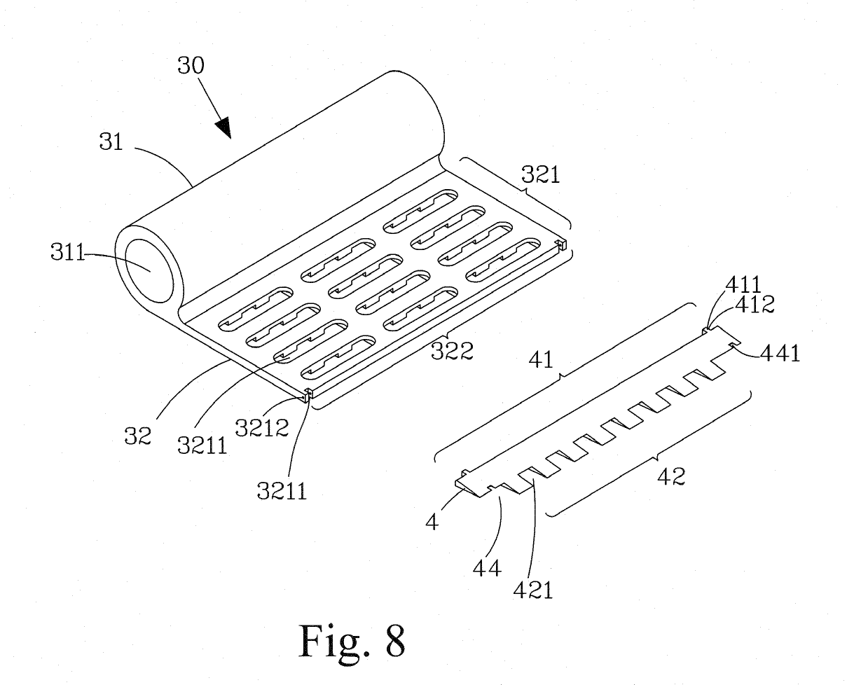

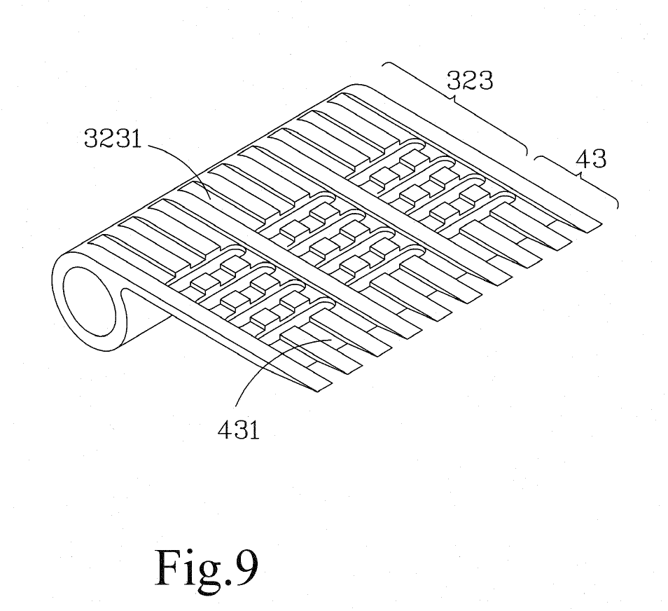

With reference to FIGS. 8 and 9, another embodiment of the present invention is illustrated. It is illustrated that the car stop plate 30 of present invention includes a stop 31 having a penetrating hole 311 for locking or being penetrated by other tool for retaining.

A supporting sheet 32 extends from a lower side to a predetermined distance and is formed with a front end 322. Thicknesses of the supporting sheet 32 are reduced from an end near the stop 11 to the front edge 322. The front edge 322 is formed with at least one groove 3211. Each lateral side of each groove 3211 is formed with a penetrating hole 3212.

A fourth action area 321 is formed at an upper surface of the supporting sheet 32. The fourth action area 321 is formed with a plurality of through holes 3221. A fifth action area 323 is formed on a bottom surface of the supporting sheet 32 opposite to the upper surface of the supporting sheet 32. The fifth action area 323 has a plurality of recesses 3231.

An engaging sheet 4 has a rear edge 41 for engaging to the front edge 322 of the supporting sheet 12. A rear edge 41 is formed with a at least one protrusion 411 which can insert into the groove 3211. Each protrusion 311 has a hole 412.

A stud can be used to insert through through the penetrating holes 3212 of at the lateral side of the groove 3211 of the supporting sheet 32 and the hole 412 of the protrusion 411 to combine the engaging sheet 4 to the supporting sheet 32.

A front edge of the engaging sheet 4 is formed as a sixth action area 42 with including a plurality of recesses 421. Two sides 44 of the front edge of engaging sheet 4 can be formed with trenches 441. A back side of the engaging sheet 4 is formed as a seventh action area 43 which is formed with a plurality of recesses 431.

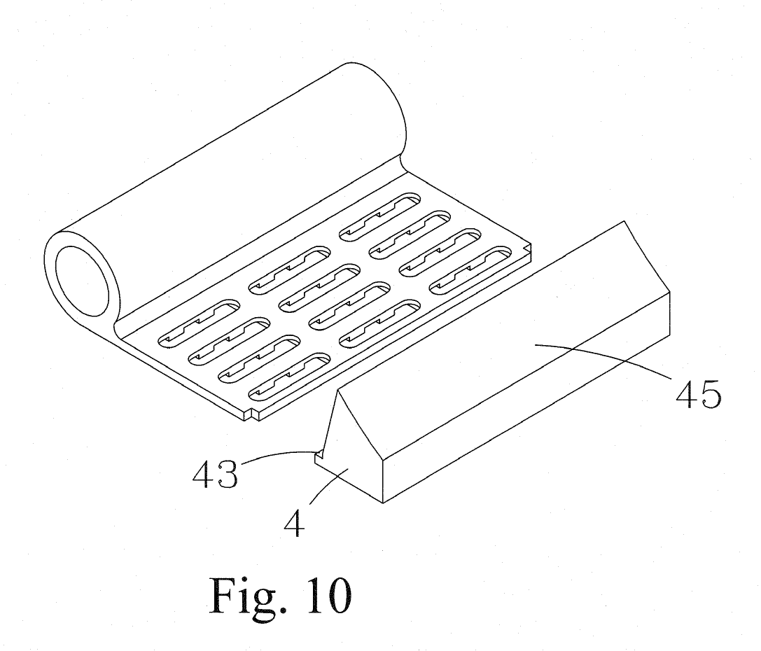

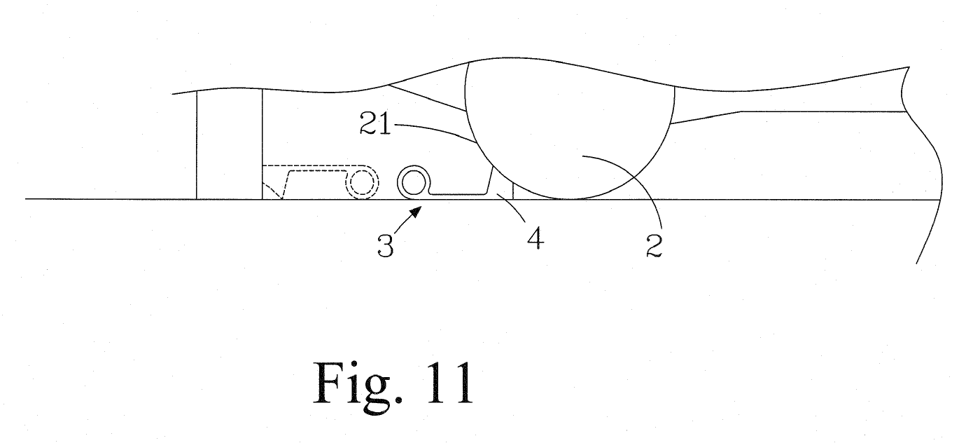

Referring to FIGS. 10 and 11, it is illustrated that in this embodiment, the engaging sheet 4 may be formed as an integral block with an inclined front surface 45 for contacting with a front side 21 of a car wheel 2. A rear side of the engaging sheet 4 is formed with a protrusion 43 to be engaged to the supporting sheet 32.

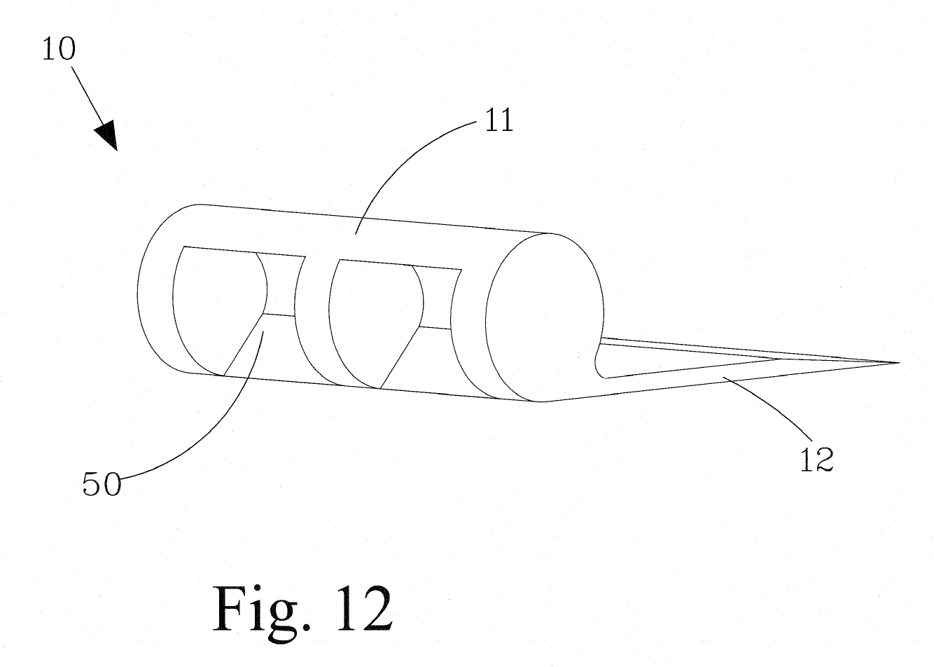

With reference to FIG. 12, it is illustrated that the supporting sheet 32 is formed with hollow space 50 for reducing the weight of the whole car stop plate.

Therefore, as shown above, the supporting sheet 32 of car stop plate 30 of the present invention can be engaged with different engaging sheet 4 to have different effect.

The present invention provides a car stop plate, in that when a driver desires to park a car, the car can be stopped quickly by resisting against the car stop plate of the present invention in a specific position. Furthermore, the present invention includes many different modules which can be assembled by matching on element to another one.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A car stop plate, comprising:
a stop having a penetrating hole for locking or being penetrated by other tool for retaining the stop;
a supporting sheet extending from a lower side to a predetermined distance; widths of the supporting sheet being reduced from an end near the stop to a front end;
wherein in use, the stop resists against a front wheel of a car; the wheel of the car will press the supporting sheet so as to retain the supporting sheet motionlessly.

2. The car stop plate as claimed in claim 1, wherein
a first action area is formed on an upper side of the supporting sheet and near the stop; and the first action area is formed with a plurality of holes;
a second action area is formed with a plurality of notches; the second action area is extended from a front end of the first action area; and the second action area is formed with a plurality of notches; and
a third action area is formed on a lower side of the supporting sheet which is opposite to the upper side of the supporting sheet; and the third action area is formed with a plurality of recesses.

3. The car stop plate as claimed in claim 2, wherein the first action area and the second action area serves to provide friction force to a car on the car stop plate and the holes of the first action area and the notches of the second action area serves to drain water; and
the recess of third action area serves to generate friction force between the supporting sheet and ground so as to reduce displacement between the supporting sheet and ground.

4. The car stop plate as claimed in claim 1, wherein a length of the supporting sheet is approximately equal to a lowest point of a wheel to a front end of a car or to a rear end of a car.

5. The car stop plate as claimed in claim 1, wherein two sides of the front edge of the first action area exposes out and each expose front side is formed with a groove for receiving a respective engaging rod.

6. The car stop plate as claimed in claim 5, wherein each lateral side of each groove is formed with a penetrating hole; and each engaging rod has a protruded stem which is formed with an engaging hole; in assembly, a stud serves to pass through the penetrating holes of the groove and the engaging hole of the engaging rod so as to retain the engaging rod to the first action area so that the length of the whole supporting sheet is prolonged.

7. A car stop plate, comprising:
a stop having a penetrating hole for locking or being penetrated by other tool for retaining the stop; and
a supporting sheet extending from a lower side to a predetermined distance and being formed with a front end; thicknesses of the supporting sheet are reduced from a end near the stop to the front edge; and
an engaging sheet having a rear edge for engaging to the front edge of the supporting sheet;

8. The car stop plate as claimed in claim 7, wherein the front edge of the supporting sheet is formed with at least one groove; each lateral side of each groove is formed with a penetrating hole; a rear edge of the engaging sheet is formed with at least one protrusion which can insert into the groove of the supporting sheet; and the at least one protrusion having a hole, a stud is used to insert through the penetrating holes of at the lateral side of the groove of the supporting sheet and the hole of the protrusion to combine the engaging sheet to the supporting sheet.

9. The car stop plate as claimed in claim 7, wherein
a fourth action area is formed on an upper surface of the supporting sheet; the fourth action area is formed with a plurality of through holes; and
a fifth action area is formed on a bottom surface of the supporting sheet of the supporting sheet which is opposite to the upper surface of the supporting sheet; and the fifth action area has a plurality of recesses.

10. The car stop plate as claimed in claim 7, wherein
a front edge of the engaging sheet is formed as a sixth action area which includes a plurality of recesses; two sides of the front edge of engaging sheet are formed with trenches; a back side of the engaging sheet is formed as a seventh action area which is formed with a plurality of recesses.

11. The car stop plate as claimed in claim 7, wherein
the engaging sheet is formed as an integral block with an inclined front surface for contacting with a front side of a car wheel; and a rear side of the engaging sheet is formed with a protrusion to be engaged to the supporting sheet.

12. The car stop plate as claimed in claim 8, wherein the supporting sheet is formed with hollow space for reducing the weight of the whole car stop plate.

13. The car stop plate as claimed in claim 7, wherein a length of the supporting sheet being based on a distance from lowest point of a wheel of a car to a foremost or rearmost of the car;
